(19) United States
(12) Patent Application Publication
(10) Pub. No.: US 2011/0102481 A1
(43) Pub. Date: May 5, 2011

(54) DRIVING METHOD FOR ELECTROPHORETIC DISPLAY DEVICE, ELECTROPHORETIC DISPLAY DEVICE, AND ELECTRONIC APPARATUS

(75) Inventors: Eiji MIYASAKA, Suwa (JP); Hiroshi MAEDA, Suwa (JP)

(73) Assignee: Seiko Epson Corporation, Tokyo (JP)

(21) Appl. No.: 12/914,108

(22) Filed: Oct. 28, 2010

(30) Foreign Application Priority Data
Nov. 4, 2009 (JP) 2009-252766

(51) Int. Cl. G09G 5/10; G09G 3/34

(52) U.S. Cl. 345/690; 345/107

(57) ABSTRACT

Disclosed is a method for driving an electrophoretic display device including a display unit having an electrophoretic element interposed between a pair of substrates, a pixel, a pixel electrode provided for each pixel and an opposite electrode facing the pixel electrode via the electrophoretic element. A step of performing an intermediate grayscale display of the pixel includes a first display step of changing the grayscale of the pixel to a first grayscale, a discharge step of removing charges of the pixel electrode and the opposite electrode, and a second display step of changing the grayscale of the pixel to an intermediate grayscale by inputting a potential for changing the grayscale of the pixel to a second grayscale to the pixel electrode and the opposite electrode.

### BACKGROUND

1. Technical Field

The present invention relates to a driving method for an electrophoretic display device, the electrophoretic display device, and an electronic apparatus.

2. Related Art

In an electrophoretic display device, a driving method (common oscillation driving) for preventing a driving voltage from being increased more than necessary by changing the potential of a common electrode has been known in the art (for example, refer to JP-A-2009-175492).

In the driving method disclosed in JP-A-2009-175492, a display with high contrast is performed by repeatedly writing the same image several times. However, JP-A-2009-175492 is not manifested such that intermediate grayscale (gray grayscale) is displayed with high quality. According to the characteristics of an electrophoretic display device, the density of gray grayscale is not easily stabilized as compared with black and white density. For example, even if the same driving pulse is used, the density of a gray display may be different for each panel due to variation in current characteristics of each panel and the like.

### SUMMARY

An advantage of some aspects of the invention is to provide a driving method for an electrophoretic display device capable of performing an intermediate grayscale display of stable density, which is rarely affected by current characteristics of a panel and the like, and the electrophoretic display device.

According to a first aspect of the invention, there is provided a method for driving an electrophoretic display device including a display unit having an electrophoretic element interposed between a pair of substrates, a plurality of arranged pixels, a pixel electrode provided for each pixel and an opposite electrode facing the pixel electrode via the electrophoretic element, wherein a step of performing an intermediate grayscale display of the pixel includes: a first display step of changing the grayscale of the pixel to a first grayscale; a discharge step of removing charges of the pixel electrode and the opposite electrode belonging to at least the pixel; and a second display step of changing the grayscale of the pixel to an intermediate grayscale by inputting a potential for changing the grayscale of the pixel to a second grayscale to the pixel electrode and the opposite electrode belonging to the pixel.

According to the driving method, the discharge step is provided, so that charges of a pixel electrode belonging to a pixel to be displayed can be removed at the time of the start of the second display step in which an intermediate grayscale display operation is performed. Consequently, a current flowing through the electrophoretic element can be prevented from being changed by the influence of remaining charges of a pixel electrode in the intermediate grayscale display operation, and an intermediate grayscale display of desired density can be achieved in each pixel.

In the second display step, it is preferable that the grayscale of the pixel is changed to the intermediate grayscale of a grayscale value, which approximates more to the second grayscale than the first grayscale.

According to the driving method, since the amount of change in a grayscale value when performing the intermediate grayscale display can be increased, a voltage application time in the intermediate grayscale display operation can be increased. Since the density of the electrophoretic element is significantly changed at the time of the start of voltage application and is gradually changed with the passage of time, the voltage application time is increased as described above, so that it is possible to prevent variation in density. For example, the driving method is performed by changing the grayscale of the pixel to an intermediate grayscale of a grayscale value which approximates more to grayscale of image data used for the second display step than grayscale of image data used for the first display step.

Preferably, after the second display step, the driving method further includes an image holding step of maintaining a high impedance state of the pixel electrode and the opposite electrode.

According to the driving method, the image holding step is provided, so that the high impedance state of the pixel electrode and the opposite electrode can be maintained without applying an electric field to the electrophoretic element. Consequently, the movement of electrophoretic particles of the electrophoretic element can converge in the maintaining period and an intermediate grayscale display of desired density can be achieved.

Preferably, between the discharge step and the second display step, the method further includes a standby step of maintaining a high impedance state of the pixel electrode and the opposite electrode.

According to the driving method, the standby step is provided, so that the movement of charges occurring in the discharge step can converge and the state of charges in the electrophoretic element, the pixel electrode and the opposite electrode can be stabilized when the second display step is started. Consequently, it is possible to prevent variation in a current flowing through the electrophoretic element in the second display step and the density of intermediate grayscale can be made uniform.

According to a second aspect of the invention, there is provided a method for driving an electrophoretic display device including a display unit having an electrophoretic element interposed between a pair of substrates, a plurality of arranged pixels, a pixel electrode provided for each pixel and an opposite electrode facing the pixel electrode via the electrophoretic element, wherein a step of performing an intermediate grayscale display of the pixel includes: a first display step of changing the grayscale of the pixel to a first grayscale; and a second display step of changing the grayscale of the pixel to an intermediate grayscale of a grayscale value, which approximates more to a second grayscale than the first grayscale, by inputting a potential for changing the grayscale of the pixel to a second grayscale to the pixel electrode and the opposite electrode belonging to the pixel.

According to the driving method, since the amount of change in a grayscale value when performing the intermediate grayscale display can be increased, a voltage application time in the intermediate grayscale display operation can be increased. Since the density of the electrophoretic element is significantly changed at the time of the start of voltage application and is gradually changed with the passage of time, the voltage application time is increased as described above, so that it is possible to prevent variation in density. For example, the driving method is performed by changing the grayscale of the pixel to an intermediate grayscale of a grayscale value which approximates more to grayscale of image data used for the second display step than grayscale of image data used for the first display step.

According to a third aspect of the invention, there is provided an electrophoretic display device including: a display unit having an electrophoretic element interposed between a pair of substrates, a plurality of arranged pixels, a pixel electrode provided for each pixel and an opposite electrode facing the pixel electrode via the electrophoretic element; and a control unit that controls driving of the pixel, wherein, when performing an intermediate grayscale display of the pixel, the control unit performs a first display operation for changing the grayscale of the pixel to a first grayscale, a discharge operation for removing charges of the pixel electrode and the opposite electrode belonging to at least the pixel and a second display operation for changing the grayscale of the pixel to an intermediate grayscale by inputting a potential for changing the grayscale of the pixel to a second grayscale to the pixel electrode and the opposite electrode belonging to the pixel.

With such a configuration, in the discharge operation, charges of a pixel electrode belonging to a pixel to be displayed can be removed at the time of the start of the second display operation in which an intermediate grayscale display operation is performed. Consequently, a current flowing through the electrophoretic element can be prevented from being changed by the influence of remaining charges of a pixel electrode in the intermediate grayscale display operation, and an intermediate grayscale display of desired density can be achieved in each pixel.

In the second display operation, it is preferable that the grayscale of the pixel is changed to the intermediate grayscale of a grayscale value, which approximates more to the second grayscale than the first grayscale.

With such a configuration, since the amount of change in a grayscale value when performing the intermediate grayscale display can be increased, a voltage application time in the intermediate grayscale display operation can be increased. Since the density of the electrophoretic element is significantly changed at the time of the start of voltage application and is gradually changed with the passage of time, the voltage application time is increased as described above, so that it is possible to prevent variation in density. For example, the configuration is realized by changing the grayscale of the pixel to an intermediate grayscale of a grayscale value, which approximates more to grayscale of image data used for the second display operation than grayscale of image data used for the first display operation.

After the second display operation, it is preferable that the control unit further performs an image holding operation for maintaining a high impedance state of the pixel electrode and the opposite electrode, after the second display operation.

With such a configuration, the image holding operation is performed, so that the high impedance state of the pixel electrode and the opposite electrode can be maintained without applying an electric field to the electrophoretic element. Consequently, the movement of electrophoretic particles of the electrophoretic element can converge in the maintaining period and an intermediate grayscale display of desired density can be achieved.

Preferably, the control unit further performs a standby operation for maintaining a high impedance state of the pixel electrode and the opposite electrode between the discharge operation and the second display operation.

With such a configuration, the standby operation is provided, so that the movement of charges occurring in the discharge operation can converge and the state of charges in the electrophoretic element, the pixel electrode and the opposite electrode can be stabilized when the second display operation is started. Consequently, it is possible to prevent variation in a current flowing through the electrophoretic element in the second display operation and the density of intermediate grayscale can be made uniform.

According to a fourth aspect of the invention, there is provided an electrophoretic display device including: a display unit having an electrophoretic element interposed between a pair of substrates, a plurality of arranged pixels, a pixel electrode provided for each pixel and an opposite electrode facing the pixel electrode via the electrophoretic element; and a control unit that controls driving of the pixel, wherein, when performing an intermediate grayscale display of the pixel, the control unit performs a first display operation for changing the grayscale of the pixel to a first grayscale, and a second display operation for changing the grayscale of the pixel to an intermediate grayscale of a grayscale value, which approximates more to the second grayscale than the first grayscale, by inputting a potential for changing the grayscale of the pixel to a second grayscale to the pixel electrode and the opposite electrode belonging to the pixel.

With such a configuration, since the amount of change in a grayscale value when performing the intermediate grayscale display can be increased, a voltage application time in the intermediate grayscale display operation can be increased. Since the density of the electrophoretic element is significantly changed at the time of the start of voltage application and is gradually changed with the passage of time, the voltage application time is increased as described above, so that it is possible to prevent variation in density. For example, the configuration is realized by changing the grayscale of the pixel to an intermediate grayscale of a grayscale value which approximates more to grayscale of image data used for the second display operation than grayscale of image data used for the first display operation.

An electronic apparatus of the present invention is provided with the above-described electrophoretic display device.

With such a configuration, it is possible to provide an electronic apparatus including a display means capable of performing an intermediate grayscale display with high quality.

### BRIEF DESCRIPTION OF THE DRAWINGS

The invention will be described with reference to the accompanying drawings, wherein like numbers reference like elements.

FIG. 1 is a diagram schematically showing the configuration of an electrophoretic display device in accordance with a first embodiment.

FIG. 2 is a circuit block diagram showing a display member.

FIG. 3 is a diagram showing a pixel circuit.

FIGS. 4A and 4B are a partial sectional view of a display member and a sectional view of a microcapsule.

FIG. 5 is a flow chart showing a driving method in accordance with a first embodiment.

FIGS. 6A and 6B are diagrams explaining transition of image data and a screen.

FIG. 7 is a timing chart showing a driving method in accordance with a first embodiment.

FIGS. 8A and 8B are diagrams explaining transition of image data and a screen in accordance with a second embodiment.

FIG. 9 is a timing chart showing a driving method in accordance with a second embodiment.

FIG. 10 is a graph showing reflection density in each panel in accordance with an existing driving method.

FIG. 11 is a graph showing reflection density in each panel in driving methods in accordance with an example.

FIG. 12 is a diagram showing one example of an electronic apparatus.

FIG. 13 is a diagram showing one example of an electronic apparatus.

FIG. 14 is a diagram showing one example of an electronic apparatus.

### DESCRIPTION OF EXEMPLARY EMBODIMENTS

Hereinafter, an electrophoretic display device and a driving method thereof in accordance with the present invention will be described with reference to the accompanying drawings.

The scope of the present invention is not limited to the following embodiments, and various modified examples can be made within the technical features of the present invention. Furthermore, in the following drawings, for the purpose of a clear explanation of elements, the sizes and the number of the elements may be reduced or magnified from the real structure thereof.

### First Embodiment

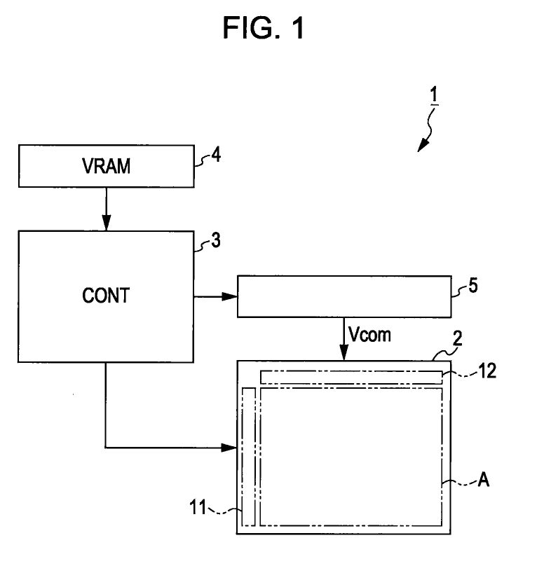

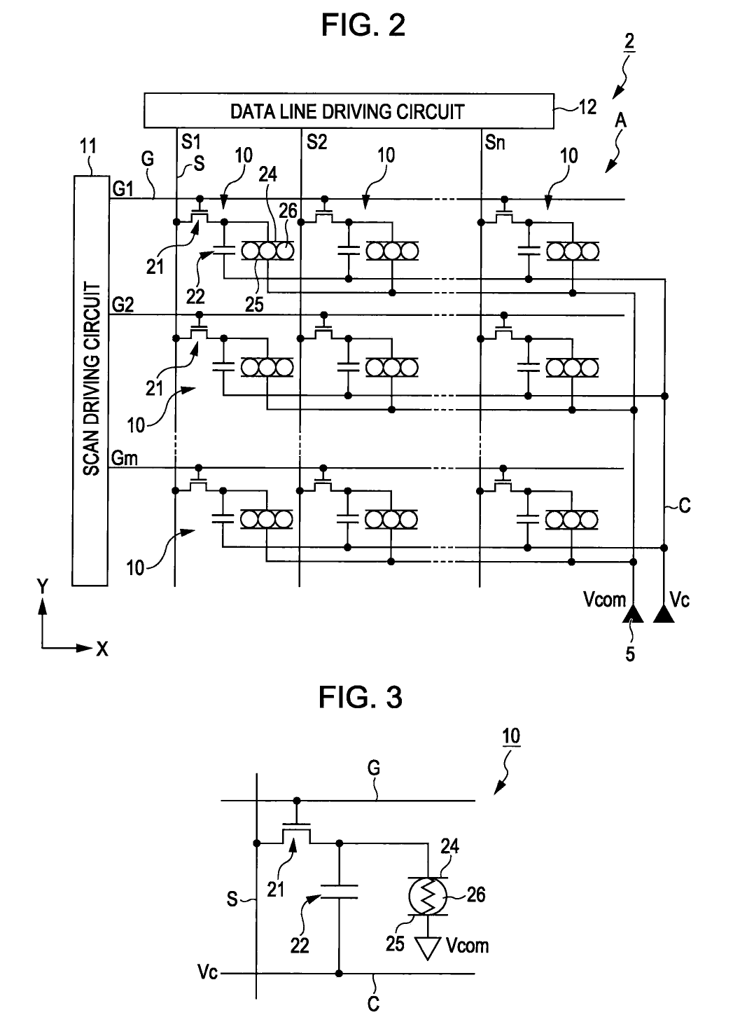

FIG. 1 is a diagram schematically showing the configuration of an electrophoretic display device which is one embodiment of an electro-optic device in accordance with the present invention. FIG. 2 is a circuit block diagram showing a display member in accordance with the first embodiment. FIG. 3 is a diagram showing a pixel circuit of the electrophoretic display device.

The electrophoretic display device 1 shown in FIG. 1 includes a display member 2, a controller 3, a VRAM (Video Random Access Memory) 4, and a common electrode driving circuit 5.

The display member 2 receives a control signal from the controller 3 and a voltage from the common electrode driving circuit 5, thereby displaying an image. The display member 2 includes a display unit A, a scanning line driving circuit 11, and a data line driving circuit 12.

The controller 3 is a control unit of the electrophoretic display device 1, receives image data to be displayed from the VRAM 4, and controls the display member 2 to display an image. In detail, the controller 3 controls the scanning line driving circuit 11 and the data line driving circuit 12, which are provided in the display member 2, and the common electrode driving circuit 5, thereby displaying the image. The control signal output from the controller 3, for example, includes a clock signal, a timing signal such as a start pulse signal, image data, a supply voltage and the like.

The VRAM 4 is used for temporarily storing one or plural items of image data, which is to be sequentially displayed on the display unit A, of image data stored in a storage unit (not shown) of a flash memory and the like.

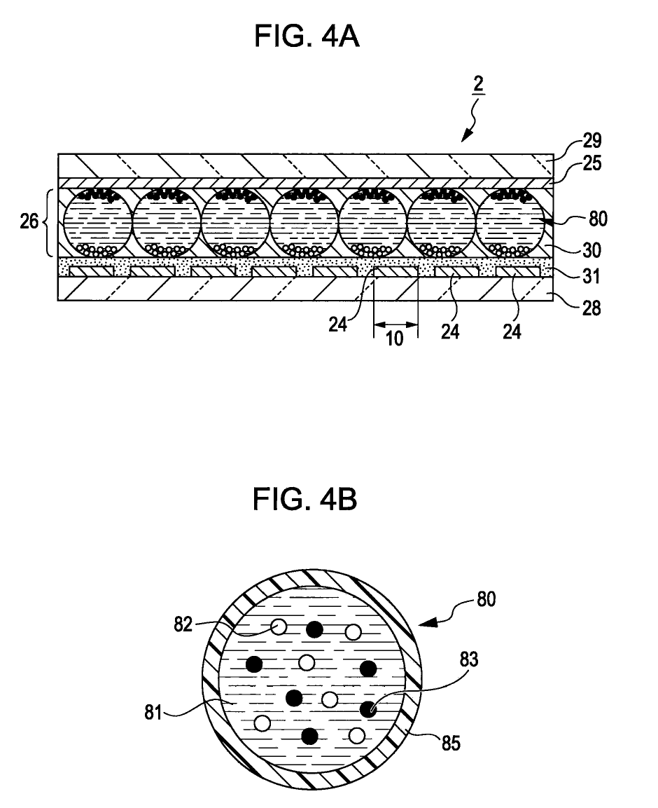

The common electrode driving circuit 5 is connected to a common electrode 25 (an opposite electrode, refer to FIGS. 2 and 4) provided in the display member 2, and supplies the common electrode 25 with an arbitrary common electrode voltage Vcom.

As shown in FIG. 2, the display unit A of the display member 2 includes a plurality of scanning lines G1, G2, . . . , Gm extending in an X axis direction and a plurality of data lines S1, S2, . . . , Sn extending in a Y axis direction. Each pixel 10 is formed corresponding to intersection parts of the scanning line G and the data line S, and the scanning line G and the data line S are connected to the respective pixels 10. The pixels 10 are arranged in a matrix form of m rows in the Y axis direction and n columns in the X axis direction. Furthermore, the common electrode 25 connected to the common electrode driving circuit 5 is formed in the display unit A.

In addition, in this specification, when the whole of each wiring is shown or the sequence (position) of wirings is not designated, an expression of a scanning line G and a data line S will be used.

FIG. 3 is a diagram showing a pixel circuit in accordance with the first embodiment.

Each pixel 10 includes a select transistor 21 serving as a pixel switching element, a holding capacitor 22, a pixel electrode 24, a common electrode 25, and an electrophoretic element 26 (an electro-optic layer).

The select transistor 21 is formed of an N-MOS (Negative Metal Oxide Semiconductor) TFT (Thin Film Transistor). The select transistor 21 has a gate connected to the scanning line G, a source connected to the data line S, and a drain connected to one electrode of the holding capacitor 22 and the pixel electrode 24.

The holding capacitor 22 is formed on an element substrate which will be described later and includes a pair of electrodes facing each other through a dielectric film. The holding capacitor 22 has one electrode connected to the select transistor 21, and the other electrode connected to a capacitor line C. An image signal written through the select transistor 21 can be maintained for a constant time by the holding capacitor 22.

The electrophoretic element 26 includes a plurality of microcapsules containing electrophoretic particles, respectively.

The scanning line driving circuit 11 shown in FIG. 2 is connected to the scanning line G formed in the display unit A, and is connected to the pixels 10 of corresponding pixel rows through the scanning line G.

The scanning line driving circuit 11 sequentially supplies a selection signal having a pulse shape to the scanning lines G1, G2, . . . , Gm based on a timing signal supplied from the controller 3, and allows each scanning line G to be exclusively sequentially in a selection state. In the selection state, the select transistor 21 connected to the scanning line G is turned on.

The data line driving circuit 12 is connected to the data line S formed in the display unit A, and is connected to the pixels 10 of corresponding pixel columns through the data line S.

The data line driving circuit 12 supplies an image signal to the data lines S1, S2, . . . , Sn based on a timing signal supplied from the controller 3. In the first embodiment, for the purpose of convenience, the image signal has a binary potential of a high level potential VH (e.g., 15 V) or a low level potential VL (e.g., 0 V). In addition, in the first embodiment, the low level image signal (potential VL) is supplied to the pixel 10 through which a white is to be displayed, and the high level image signal (potential VH) is supplied to the pixel 10 through which a black is to be displayed.

The common electrode 25 receives the common electrode voltage Vcom from the common electrode driving circuit 5. The common electrode driving circuit 5 is configured to generate an arbitrary potential waveform and can perform common oscillation driving to change the common electrode voltage Vcom according to a grayscale written in the pixel 10.

In addition, in the description of the driving method which will be described later, for the simplification of description, the common electrode voltage Vcom has a binary potential of a low level potential VL (e.g., 0 V) or a high level potential VH (e.g., 15 V).

A capacitor line potential Vc is supplied to the capacitor line C from a driving circuit (not shown). A dedicated driving circuit for driving the capacitor line C may be prepared, or the scanning line driving circuit 11 or the common electrode driving circuit 5 may also serve as a driving circuit for the capacitor line. The capacitor line C may be maintained at a constant potential (e.g., a ground potential), or may receive a plurality of potentials (e.g., a low level potential VL and a high level potential VH).

FIG. 4A is a partial sectional view of the display member.

The display member 2 has a configuration in which the electrophoretic element 26 is interposed between an element substrate 28 and an opposite substrate 29. In the first embodiment, an image is displayed on the side of the opposite substrate 29.

For example, the element substrate 28 is made of glass, plastic and the like. A stack structure including the above-described select transistor 21, holding capacitor 22, scanning line G, data line S, capacitor line C and the like is formed on the element substrate 28. A plurality of pixel electrodes 24 is arranged on an upper layer side of the stack structure in a matrix form.

For example, the opposite substrate 29 is a transparent substrate made of glass, plastic and the like. The common electrode 25 is densely formed on the side of the opposite substrate 29 with respect to the element substrate 28 while facing the plurality of pixel electrodes 24. For example, the common electrode 25 is formed of a transparent conductive material such as magnesium-silver (MgAg), ITO (Indium Tin Oxide) or IZO (Indium Zinc Oxide).

The electrophoretic element 26 includes a plurality of microcapsules 80 containing electrophoretic particles, respectively. The plurality of microcapsules 80, for example, is fixed between the element substrate 28 and the opposite substrate 29 by a binder 30 including resin and the like and an adhesive layer 31.

In addition, the display member 2 is fabricated by bonding an electrophoretic sheet to the element substrate 28, on which the pixel electrodes 24 and the like are formed, by using an adhesive layer 31. The electrophoretic sheet is obtained by fixing in advance the electrophoretic element 26 to the side of the opposite substrate 29 by using the binder 30, and the element substrate 28 is fabricated separately from the electrophoretic sheet.

The microcapsule 80 is interposed between the pixel electrodes 24 and the common electrode 25. One or a plurality of microcapsules 80 are disposed in one pixel 10 (in other words, with respect to one pixel electrode 24).

FIG. 4B is a schematic sectional view of the microcapsule.

In FIG. 4B, the microcapsule 80 has a configuration in which a dispersion medium 81, a plurality of white particles 82 and a plurality of black particles 83 are encapsulated in a film 85. For example, the microcapsule 80 has a spherical shape having a grain size of about 50 μm. In addition, the white particles 82 and the black particles 83 are one example of “electrophoretic particles” according to the embodiment of the present invention.

The film 85 serves as an outer shell of the microcapsule 80, and is formed using acryl resin such as polymethyl methacrylate or polyethyl methacrylate, urea resin, polymeric resin with transparency such as gum arabic, and the like.

The dispersion medium 81 is a medium for dispersing the white particles 82 and the black particles 83 into the microcapsule 80 (in other words, the film 85). As the dispersion medium 81, it is possible to exemplify water, an alcoholic-based solvent (methanol, ethanol, isopropanol, butanol, octanol, methyl cellosolve and the like), esters (ethyl acetate, butyl acetate and the like), ketones (acetone, methyl ethyl ketone, methyl isobutyl ketone and the like), aliphatic hydrocarbons (pentane, hexane, octane and the like), alicyclic hydrocarbons (cyclo hexane, methyl cyclo hexane and the like), aromatic hydrocarbons (benzene, toluene, benzenes having a long-chain alkyl group (xylene, hexyl benzene, hebutyl benzene, octyl benzene, nonyl benzene, decyl benzene, undecyl benzene, dodecyl benzene, tridecyl benzene, tetra decyl benzene and the like)), halogenated hydrocarbons (methylene chloride, chloroform, carbon tetrachloride, 1,2-dichloroethane and the like), carboxylate, and the like. Furthermore, other oils may be exemplified. These materials may be used by themselves or in a mixture. In addition, a surface active agent and the like may also be mixed therein.

The white particles 82, for example, are particles (polymer or colloid) including white pigments such as titanium dioxide, zinc oxide or antimony trioxide. For example, the white particles 82 are used after being negatively charged. The black particles 83, for example, are particles (polymer or colloid) including black pigments such as aniline black or carbon black. For example, the black particles 83 are used after being positively charged.

It is possible to add a charge control agent including particles such as an electrolyte, a surface active agent, metal soap, resin, rubber, oil, varnish or compound, a dispersion agent such as a titanium-based coupling agent, an aluminum-based coupling agent or a silane-based coupling agent, a lubricant, a stabilizing agent, and the like to the pigments, as is required.

Furthermore, instead of the white particles 82 and the black particles 83, for example, pigments of red, green, blue and the like may also be used. With such a configuration, red, green, blue and the like can be displayed on the display unit.

### Driving Method

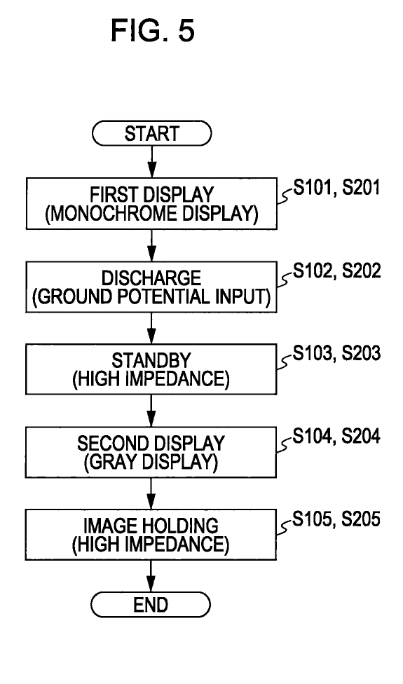

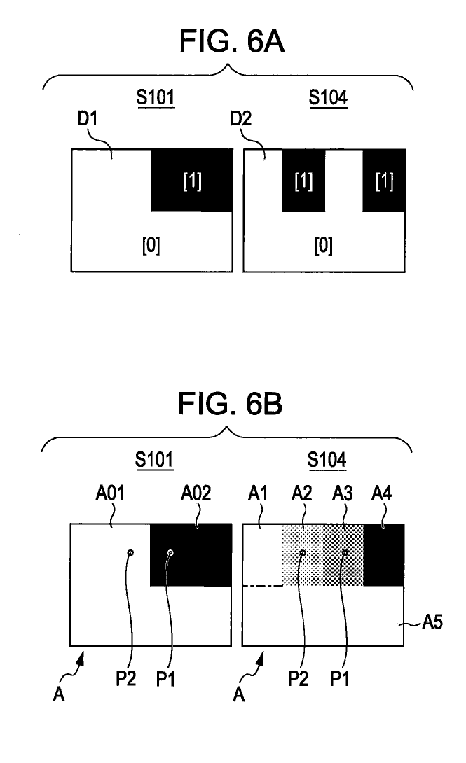

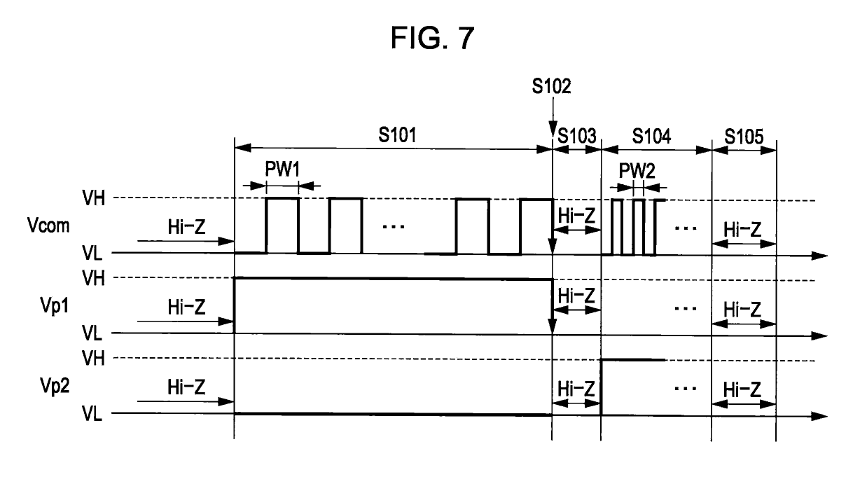

FIG. 5 is a flow chart showing a processing flow in the driving method of the electrophoretic display device in accordance with the first embodiment. FIG. 6A is a diagram showing transition of image data used for the driving method of the first embodiment. FIG. 6B is a diagram showing state transition of the display unit A. FIG. 7 is a timing chart corresponding to FIG. 5.

In the first embodiment, specifically, the pixel 10, which belongs to an area A3 shown in FIG. 6B and is displayed in dark gray in step S104, and the pixel 10, which belongs to an area A2 and is displayed in light gray in step S104, will be described in detail.

In FIG. 7, “Vp1” represents a potential which is input to the pixel electrode 24 of the pixel 10 (the pixel P1 belonging to the area A3) displayed in dark gray in step S104, and “Vp2” represents a potential which is input to the pixel electrode 24 of the pixel 10 (the pixel P2 belonging to the area A2) displayed in light gray in step S104.

In addition, in the first embodiment, a description will be given on the assumption that the white particles 82 of the electrophoretic particles are charged with a negative polarity and the black particles 83 are charged with a positive polarity. Thus, when the pixel electrode 24 and the common electrode 25 are driven by receiving any one of a low level potential VL (0 V) and a high level potential VH (15 V), if Vcom is at a high level (VH; 15 V), the pixel 10 including the pixel electrode 24 at a low level (VL; 0 V) is displayed in white and a display of the pixel 10 including the pixel electrode 24 at a high level (VH; 15 V) does not change. Meanwhile, if Vcom is at a low level (VL; 0 V), the pixel 10 including the pixel electrode 24 at a high level (VH; 15 V) is displayed in black and a display of the pixel 10 including the pixel electrode 24 at a low level (VL; 0 V) does not change.

The driving method of the first embodiment relates to an image display operation for displaying an image including intermediate grayscale on the display unit A through steps S101 to S105 shown in FIG. 5. Thus, for example, when the controller 3 receives a display member driving start command through the pressing of a button (not shown) by a user and the like, steps S101 to S105 are sequentially performed.

First, in the display unit A immediately before the image display operation starts, as shown in FIG. 7, since all the pixel electrodes 24 and common electrode 25 are in a high impedance state representing electrical disconnection, a state in which a voltage is not applied to the electrophoretic element 26 is maintained.

If the image display operation starts and step S101 (first display) is performed, the controller 3 reads image data D1 shown in FIG. 6A from the VRAM 4 and displays the image data D1 on the display unit A.

In addition, in relation to the image data D1, a part corresponding to the right upper area A02 (with an area ratio of 1/4) of the display unit A shown in FIG. 6B includes image data “1” (corresponding to black display), and a part corresponding to a remaining area A01 (with an area ratio of 3/4) includes image data “0” (corresponding to white display).

In more detail, in step S101 (first display), under the control of the controller 3, the scanning line G is sequentially selected by the scanning line driving circuit 11, and an image signal corresponding to one row of the image data D1 is input from the data line driving circuit 12 to the pixel electrode 24 of the pixel 10 connected to the selected scanning line G. Through such an operation, as shown in FIG. 7, the potential Vp1 of the pixel electrode 24 of the pixel P1 displayed in dark gray is at a high level (VH; 15 V) and the potential Vp2 of the pixel electrode 24 of the pixel P2 displayed in light gray is at a low level (VL; 0 V). Furthermore, the common electrode 25 receives a pulse with a rectangular wave, which periodically repeats a high level (VH) and a low level (VL).

In the period in which the potential Vcom of the common electrode 25 is at a low level (VL), since the potential Vp1 of the pixel electrode 24 is relatively high and the potential Vcom of the common electrode 25 is relatively low, the pixel P1 displayed in dark gray is displayed in black. Since the potential Vp2 of the pixel electrode 24 of the pixel P2 displayed in light gray and the potential Vcom of the common electrode 25 are equal to each other (VL), the electrophoretic element 26 is not driven and the display of the pixel P2 does not change.

Meanwhile, the period in which the potential Vcom of the common electrode 25 is at a high level (VH), since the potential Vp1 of the pixel electrode 24 and the potential Vcom of the common electrode 25 are equal to each other, the display of the pixel P1 displayed in dark gray does not change. Since the potential Vp2 of the pixel electrode 24 is relatively low and the potential Vcom of the common electrode 25 is relatively high, the pixel P2 displayed in light gray is displayed in white.

Through such an operation, as shown in FIG. 6B, in the display unit A, the area A01 is displayed in white and the area A02 is displayed in black.

If step S101 (first display) is ended, step S102 (discharge) is performed as shown in FIG. 5.

In step S102 (discharge), as shown in FIG. 7, a ground potential (0 V; a low level potential VL) is input to the common electrode 25 as well as all the pixel electrodes 24 of the display unit A. In detail, under the control of the controller 3, an image signal (a low level potential VL; 0 V) corresponding to image data “0” is input to the pixel electrodes 24 of all the pixels 10 by the scanning line driving circuit 11 and the data line driving circuit 12, and a low level potential VL (0 V) is input to the common electrode 25 by the common electrode driving circuit 5.

Thus, charges are extracted from the pixel electrodes 24 to which the high level potential VH is input when step S101 (first display) is ended, and charges accumulated in the holding capacitor 22 are also released. Furthermore, charges are also extracted from the common electrode 25 receiving a rectangular wave with a terminal at a high level VH. In this way, all the pixel electrodes 24 and the common electrode 25 of the display unit A have the same potential (a low level (VL)).

If step S102 (discharge) is ended, step S103 (standby) is performed.

In step S103 (standby), as shown in FIG. 7, both the pixel electrode 24 and the common electrode 25 are in a high impedance state for a predetermined time. Step S103 (standby) is for holding the execution of second display step S104 (discharge) until charges in the display member 2 are stabilized. Preferably, the execution time of step S103 (standby) is set according to the characteristics of the display member 2. In detail, for example, the execution time of step S103 (standby) is about 100 ms. Preferably, the execution time of step S103 (standby) is set in the range of about 10 ms to about 500 ms according to the characteristics of the display member 2.

In addition, step S103 (standby) may not be performed as is required. That is, when no variation occurs in the density of intermediate grayscale between panels even if the execution time of step S103 (standby) is set to be smaller than 10 ms, step S103 (standby) is not necessary.

If step S103 (standby) is ended, step S104 (second display) is performed.

In step S104 (second display), the controller 3 reads image data D2 shown in FIG. 6A from the VRAM 4 and displays the image data D2 on the display unit A.

In addition, in relation to the image data D2, a part corresponding to an area A2 (with an area ratio of 1/8) of the left upper side of the center of the display unit A shown in FIG. 6B and an area A4 (with an area ratio of 1/8) of the right upper side include image data “1” (corresponding to black display), and a part corresponding to remaining areas A1, A3 and A5 (with an area ratio of 3/4) include image data “0” (corresponding to white display).

Through such an operation, as shown in FIG. 7, the potential Vp1 of the pixel electrode 24 of the pixel P1 (the area A3) displayed in dark gray is at a low level (VL) and the potential Vp2 of the pixel electrode 24 of the pixel P2 (the area A2) displayed in light gray is at a high level (VH). Furthermore, the common electrode 25 receives a pulse with a rectangular wave, which periodically repeats a high level (VH) and a low level (VL).

In addition, in the first embodiment, the pulse width PW2 of the rectangular wave input to the common electrode 25 in step S104 (second display) is narrower than the pulse width PW1 of the rectangular wave input to the common electrode 25 in step S101 (first display). Thus, the electrophoretic element 26 can be driven bit by bit at a high frequency and an intermediate grayscale display can be controlled more reliably. The pulse width PW2 can be arbitrarily set according to the characteristics of the electrophoretic element 26 and the like. For example, the pulse width PW2 can be set to about 20 ms and the pulse width PW1 can be set to about 200 ms.

In step S104 (second display), in the period in which the potential Vcom of the common electrode 25 is at a high level (VH), since the potential Vp1 of the pixel electrode 24 is relatively low and the potential Vcom of the common electrode 25 is relatively high, the pixel P1 (belongs to the area A3) displayed in dark gray is displayed in white. Thus, the pixel P1 displayed in black in step S101 (first display) is slightly displayed in white and is displayed in dark gray. At this time, since the potential Vp2 of the pixel electrode 24 of the pixel P2 (belongs to the area A2) displayed in light gray and the potential Vcom of the common electrode 25 are equal to each other (VH), the electrophoretic element 26 is not driven and the display of the pixel P2 does not change.

Meanwhile, in the period in which the potential Vcom of the common electrode 25 is at a low level (VL), since the potential Vp2 of the pixel electrode 24 is relatively high and the potential Vcom of the common electrode 25 is relatively low, the pixel P2 displayed in light gray is displayed in black. Thus, the pixel P2 displayed in white in step S101 (first display) is slightly displayed in black and is displayed in light gray. At this time, since the potential Vp1 of the pixel electrode 24 and the potential Vcom of the common electrode 25 are equal to each other, the display of the pixel P1 displayed in dark gray does not change.

Through such an operation, as shown in FIG. 6B, in the display unit A, the area A1 is displayed in white, the area A2 (the pixel P2) is displayed in light gray, the area A3 (the pixel P1) is displayed in dark gray, and the area A4 is displayed in black.

If step S104 (second display) is ended, step S105 (image holding) is performed.

In step S105 (image holding), as shown in FIG. 7, both the pixel electrode 24 and the common electrode 25 are in a high impedance state for a predetermined time. Step S105 (image holding) is for holding the next image display operation until the state of the electrophoretic particles in the electrophoretic element 26 are stabilized. Preferably, the execution time of step S105 (image holding) is set according to the characteristics of the display member 2. In detail, for example, the execution time of S105 (image holding) is about 500 ms to about one second.

In step S105 (image holding), since both the pixel electrode 24 and the common electrode 25 are in the high impedance state, no electric field is exerted on the electrophoretic element 26. In such a state, they are in the high impedance state for the predetermined time, so that unfinished movement of the electrophoretic particles in the period of step S104 (second display) is completed and thus a gray display can reach desired density. Consequently, it is possible to exclude the influence of movement convergence of the electrophoretic particles in which variation occurs in each panel, so that density of intermediate grayscale can be prevented from changing in each panel.

In addition, in a similar manner to step S103 (standby), step S105 (image holding) may be performed as is required. That is, when the density of the gray display is stabilized immediately after step S104 (second display) is ended, step S105 (image holding) is not necessary.

In the driving method of the electrophoretic display device in accordance with the first embodiment as described above, step S102 (discharge) is provided, at the start time in point of step S104 (second display) in which the gray display operation is performed, charges of all the pixel electrodes 24 of the display unit A are removed and all the pixel electrodes 24 are set to a ground potential. Consequently, it is possible to exclude the influence of remaining charges of the pixel electrodes 24 in the gray display operation and it is possible to achieve the desired amount of change in density in each pixel 10. In more detail, in the gray display operation, since voltage application to the electrophoretic element 26 is stopped in an area where the reflectance (density) of the pixel 10 is relatively rapidly changed, variation in the amount of a current flowing through the electrophoretic element 26 may be easily equal to variation in density. In this regard, in the first embodiment, the remaining charges of the pixel electrodes 24 are removed ahead of the gray display, so that variation in the amount of a current due to the remaining charges can be prevented and a gray display with desired density can be easily achieved.

In addition, in the first embodiment, step S103 (standby) is provided, so that the charges in the display member 2 are stabilized during the start of step S104 (second display), resulting in the prevention of variation in the amount of a current. Moreover, step S105 (image holding) is provided, so that the movement of the electrophoretic particles in the electrophoretic element 26 is converged and thus the density of the gray display is stabilized. Consequently, it is possible to prevent variation in the density of the gray display caused by variation in the characteristics of the display member 2 including the electrophoretic element 26.

### Second Embodiment

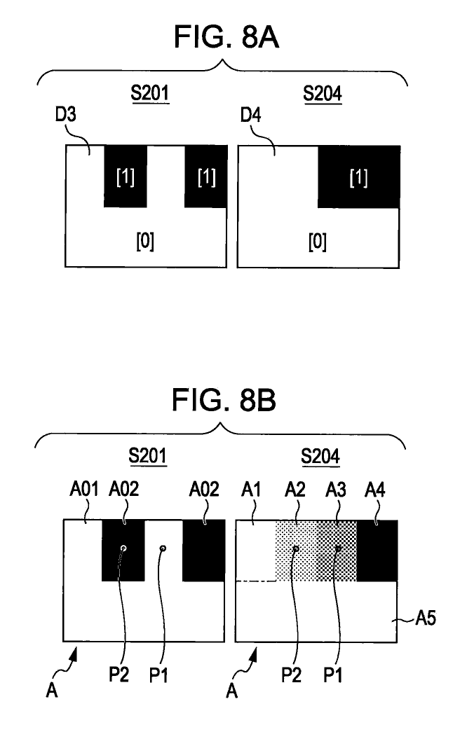

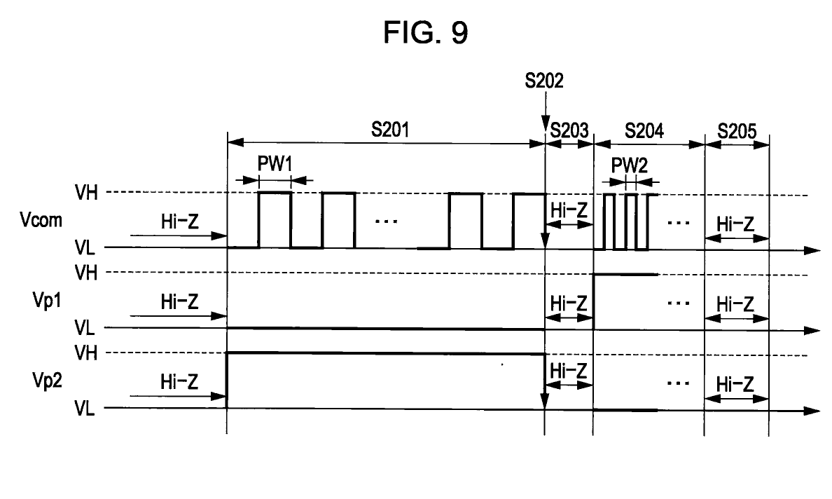

Next, a driving method of the electrophoretic display device in accordance with the second embodiment of the present invention will be described with reference to FIGS. 8A, 8B and 9.

FIG. 8A is a diagram showing transition of image data used for the driving method in accordance with the second embodiment and FIG. 8B is a diagram showing state transition of the display unit A. FIG. 9 is a timing chart explaining the driving method of the electrophoretic display device in accordance with the second embodiment. In addition, the flow of the driving method in accordance with the second embodiment includes steps S201 to S205 shown in FIG. 5.

As shown in FIG. 8A, in the second embodiment, image data D3 equal to the image data D2 in accordance with the first embodiment is used in step S201 (first display) and image data D4 equal to the image data D1 in accordance with the first embodiment is used in step S204 (second display).

In step S201 (first display), the image data D3 shown in FIG. 8A is input to the display unit A. As shown in FIG. 9, the potential Vp1 of the pixel electrode 24 of a pixel P1 displayed in dark gray is at a low level (VL) and the potential Vp2 of the pixel electrode 24 of a pixel P2 displayed in light gray is at a high level (VH). The common electrode 25 receives a rectangular wave which periodically repeats a high level (VH) and a low level (VL).

Thus, as shown in FIG. 8B, an image based on the image data D3 is displayed on the display unit A, a pixel P1 belonging to an area A01 is displayed in white, and a pixel P2 belonging to an area A02 is displayed in black.

After step S201 (first display) is ended, step S202 (discharge) and step S203 (standby) are sequentially performed in a similar manner to the first embodiment. In the second embodiment, in step S202 (discharge), charges are removed from the pixel P2 with a high level potential (VH) when step S201 (first display) is ended and the common electrode 25, and all the pixel electrodes 24 and the common electrode 25 are set to a ground potential (low level (VL)). Then, in step S203 (standby), both the pixel electrode 24 and the common electrode 25 are in a high impedance state for a predetermined time (e.g., 100 ms).

Thereafter, if step S204 (second display) is performed, as shown in FIG. 9, the potential Vp1 of the pixel electrode 24 of a pixel P1 is at a high level (VH) and the potential Vp2 of the pixel electrode 24 of a pixel P2 is at a low level (VL). The common electrode 25 receives a rectangular wave which periodically repeats a high level (VH) and a low level (VL).

If so, the pixel P1 is displayed in black in the period in which the common electrode 25 is at a low level (VL), so that the pixel P1 displayed in white in step S201 (first display) is displayed in dark gray. Furthermore, the pixel P2 is displayed in white in the period in which the common electrode 25 is at a high level (VH), so that the pixel P2 displayed in black in step S201 (first display) is displayed in light gray.

Then, in step S205 (image holding), both the pixel electrode 24 and the common electrode 25 are in a high impedance state for a predetermined time (e.g., 500 ms to one second).

That is, in the second embodiment, the pixel P1 is displayed in white and then displayed in black, thereby achieving a dark gray display. Furthermore, the pixel P2 is displayed in black and then displayed in white, thereby achieving a light gray display. Thus, in the second embodiment, the amount of change of a grayscale value (the amount of change of density) in the gray display operation (step S204 (second display)) is large, as compared with the first embodiment.

Using such a driving method, in step S204 (second display), the time for which a voltage is applied to the electrophoretic element 26 can be increased and variation in density can be prevented. This is because the density of the electrophoretic element 26 is rapidly changed at the time of the start of voltage application, and is gradually changed with the passage of time.

In addition, the second embodiment exemplifies the electrophoretic display device employing a 1T1C scheme (a DRAM scheme) in which one transistor and one capacitor are formed in one pixel. However, the driving method in accordance with the present invention can also be appropriately applied to an electrophoretic display device employing other driving schemes. For example, the driving method in accordance with the present invention can be applied to a segment-type electrophoretic display device without any problems. Furthermore, the driving method in accordance with the present invention can also be appropriately applied to an active matrix-type electrophoretic display device. For example, the driving method in accordance with the present invention can be applied to a SRAM (Static Random Access Memory) type electrophoretic display device in which a latch circuit is provided for each pixel. In addition, the driving method in accordance with the present invention can also be applied to an electrophoretic display device employing a scheme in which a transistor and a transmission gate are switched using a latch circuit and thus a control line is connected to pixel electrodes.

### Example

Hereinafter, the present invention will be described in detail with reference to the example. However, the technical scope of the present invention is not limited to the following example.

In this example, a plurality of (53) electrophoretic display devices having the configuration shown in FIGS. 1 to 3 and 4A and 4B are produced, and then variation in gray density between panels was verified. In more detail, the image including the intermediate grayscale shown in the right side of FIG. 6B is displayed using three types of driving methods 1 to 3 and an existing driving method, which will be described below, with respect to each panel, and reflection density was measured for the area A1 (displayed in white), the area A2 (displayed in light gray), the area A3 (displayed in dark gray), and the area A4 (displayed in black).

### Driving Method 1

The driving method 1 is the driving method in accordance with the first embodiment. That is, steps S101 to S105 shown in FIG. 5 are sequentially performed, so that the image including the intermediate grayscale shown in the right side of FIG. 6B is displayed.

### Driving Method 2

In the driving method 2, differently from the driving method in accordance with the second embodiment, step S202 (discharge) and step S203 (standby) are omitted, and steps S201, S204 and S205 sequentially performed using the image data D3 and D4 shown in FIGS. 8A and 8B, so that the image including the intermediate grayscale is displayed.

### Driving Method 3

The driving method 3 is the driving method in accordance with the second embodiment. That is, steps S201 to S205 shown in FIG. 5 are sequentially performed using the image data D3 and D4 shown in FIGS. 8A and 8B, so that the image including the intermediate grayscale is displayed.

### Existing Driving Method

In the existing driving method, differently from the driving method in accordance with the first embodiment, step S102 (discharge) and step S103 (standby) are omitted, and only steps S101 (first display) and S104 (second display) are continuously performed. In addition, in this example, since the refection density is measured while maintaining the state where the image including the intermediate grayscale is displayed, step S105 (image holding), in which the pixel electrodes 24 and the common electrode 25 are maintained in the high impedance state, is actually performed in the existing driving method.

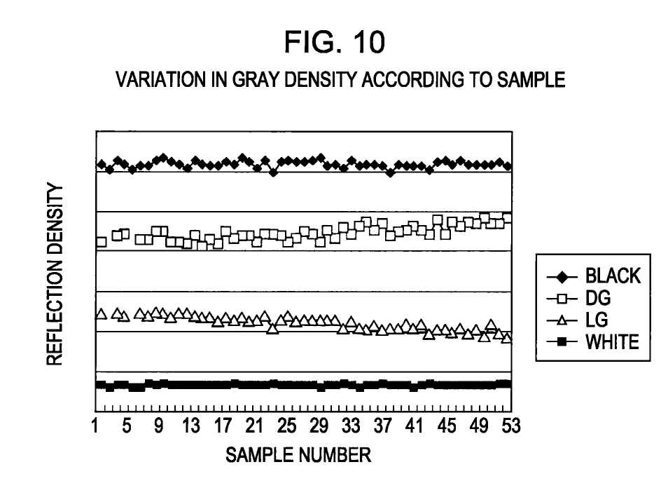

FIG. 10 is a graph showing the measurement result of the refection density when the image shown in FIG. 6B is displayed using the existing driving method. In FIG. 10, a horizontal axis indicates a sample number (a panel number) and a vertical axis indicates the refection density (an arbitrary unit).

As shown in FIG. 10, the density of a white display and the density of a black display are approximately uniform in each panel. However, the density of light gray (LG) and the density of dark gray (DG) are significantly changed in each panel. In the graph shown in FIG. 10, a panel with a small sample number represents a panel in which electrophoretic particles are relatively easily moved (a current easily flows through the electrophoretic particles). A panel with a large sample number represents a panel in which electrophoretic particles are not easily moved (a current does not easily flow through the electrophoretic particles).

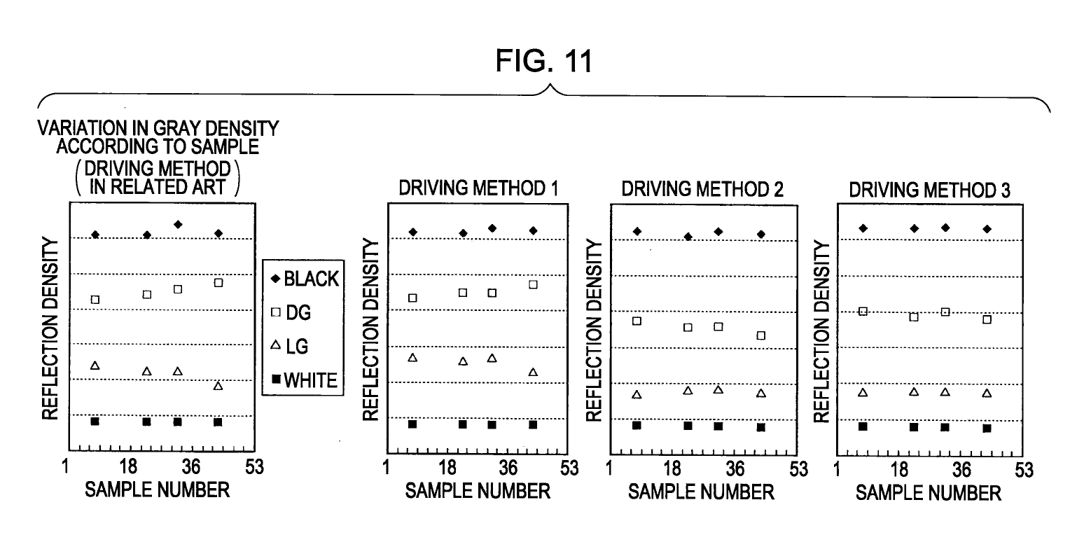

FIG. 11 is graphs showing the reflection density of each area in each panel when the image including the intermediate grayscale is displayed using the driving methods 1 to 3.

The graphs of the “existing driving method” shown in FIG. 11 is obtained by processing the graph of FIG. 10 for the purpose of comparison. Furthermore, in each graph of FIG. 11, the reflection density on the vertical axis has an arbitrary unit, but the same scale is applied for the purpose of comparison. In addition, the plot (square and triangular marks) of each graph shown in FIG. 11 indicates a panel with the same sample number.

When viewed on the graph of the “driving method 1” shown in FIG. 11, the uniformity of the reflection density of the dark gray is improved in the “driving method 1”, as compared with the graph of the “existing driving method”. Meanwhile, the uniformity of the reflection density of the light gray is not nearly changed. However, it can be understood that the reflection density is increased as a whole and the responsiveness of the electrophoretic particles is improved.

Next, when viewed on the graph of the “driving method 2”, since the white display is changed to the dark gray display and the black display is changed to the light gray display in the “driving method 2”, the level of the reflection density is changed from the “driving method 1” and the “existing driving method”. However, the uniformity of the reflection density in both the dark gray and the light gray is improved. Specifically, the uniformity of the reflection density of the dark gray is significantly improved as compared with the “existing driving method” and the “driving method 1”.

Next, when viewed on the graph of the “driving method 3”, the uniformity of the reflection density of the dark gray and the light gray are further improved in the “driving method 3” as compared with the “driving method 2”. According to the “driving method 3”, it is possible to considerably improve variation in the gray density in each panel as compared with the “existing driving method”.

According to the driving method of the electrophoretic display device in accordance with the present invention as described above, it is possible to improve variation in an intermediate grayscale display in each panel in the electrophoretic display device without using a special configuration. Consequently, the driving method of the electrophoretic display device in accordance with the present invention is a technology very useful for improving the display quality of the electrophoretic display device.

### Electronic Apparatus

Next, the case where the electrophoretic display device 1 in accordance with the previous embodiments is applied to the electronic apparatus will be described.

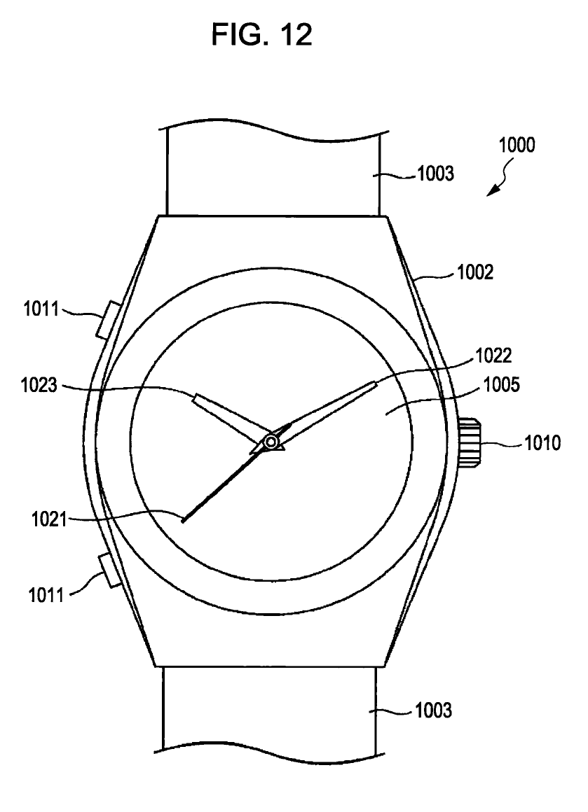

FIG. 12 is a front view of a watch 1000. The watch 1000 includes a watch case 1002 and a pair of straps 1003 connected to the watch case 1002.

The watch case 1002 is provided on the front surface thereof with a display unit 1005 of the electrophoretic display devices in accordance with the embodiment, a second hand 1021, a minute hand 1022 and an hour hand 1023. The watch case 1002 is provided on the side thereof with a winder 1010 as an operating element and an operation button 1011. The winder 1010 is connected to a winding stem pipe (not shown) provided in the case, and is configured to be freely pushed and drawn at multi-steps (e.g., two steps) as one body with the winding stem pipe, and to be freely rotated. The display unit 1005 can display a background image, a character string such as a date or a time, a second hand, a minute hand, an hour hand and the like.

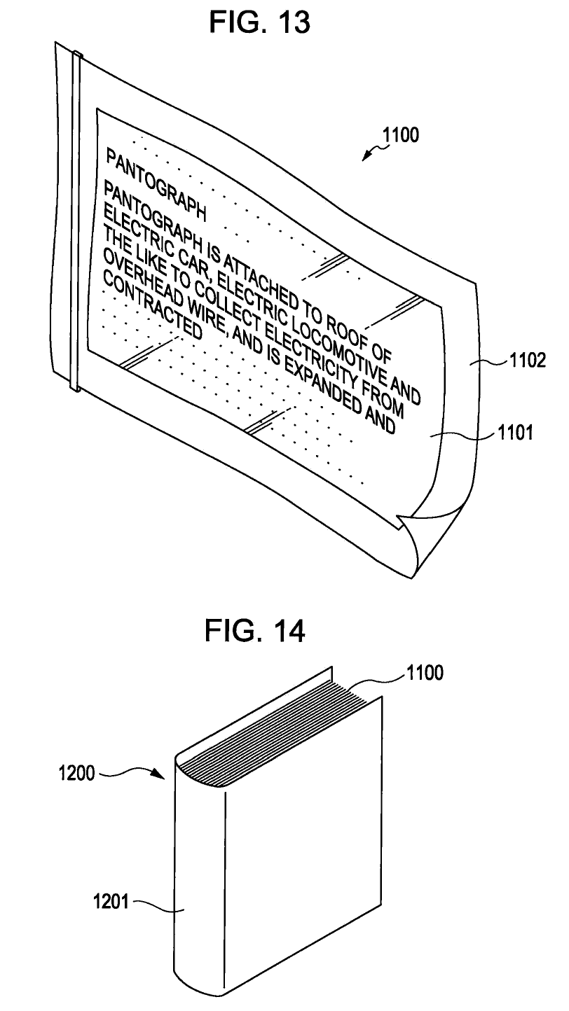

FIG. 13 is a perspective view showing the configuration of an electronic paper 1100. The electronic paper 1100 includes the electrophoretic display device of the embodiment in a display area 1101. The electronic paper 1100 has flexibility and includes a body 1102 provided with a rewritable sheet having similar feeling and flexibility to existing paper.

FIG. 14 is a perspective view showing the configuration of an electronic note 1200. The electronic note 1200 is obtained by binding a plurality of electronic papers 1100 and interposing the electronic papers 1100 in a cover 1201. The cover 1201, for example, is provided with a display data input unit (not shown) that inputs display data sent from an external apparatus. Consequently, in the state where the electronic papers are bound, display contents can be changed or updated according to the display data.

The watch 1000, the electronic paper 1100 and the electronic note 1200 employ the electrophoretic display device in accordance with the present invention, resulting in the realization of an electronic apparatus provided with a display unit capable of performing an intermediate grayscale display with high quality.

In addition, the above electronic apparatuses exemplify an electronic apparatus in accordance with the present invention, and does not limit to the technical scope of the present invention. For example, the electrophoretic display device in accordance with the present invention can be appropriately applied to a display unit of an electronic apparatus such as a cell phone or a portable audio system.

The entire disclosure of Japanese Patent Application No. 2009-252766, filed Nov. 4, 2009 is expressly incorporated by reference herein.

1. A method for driving an electrophoretic display device including a display unit having an electrophoretic element interposed between a pair of substrates, a pixel, a pixel electrode provided for the pixel and an opposite electrode facing the pixel electrode via the electrophoretic element, wherein performing an intermediate grayscale display of the pixel comprises:
changing a grayscale of the pixel to a first grayscale;
removing charges of the pixel electrode and the opposite electrode; and
changing the grayscale of the pixel to an intermediate grayscale by inputting a potential for changing the grayscale of the pixel to a second grayscale to the pixel electrode and the opposite electrode.

2. The method according to claim 1, wherein, in the changing of the grayscale of the pixel to the intermediate grayscale, the grayscale of the pixel is changed to the intermediate grayscale of a grayscale value, which approximates more to the second grayscale than the first grayscale.

3. The method according to claim 1, further comprising maintaining a high impedance state of the pixel electrode and the opposite electrode, after the changing of the grayscale of the pixel to the intermediate grayscale.

4. The method according to claim 1, further comprising maintaining a high impedance state of the pixel electrode and the opposite electrode between the removing of the charges of the pixel electrode and the opposite electrode and the changing of the grayscale of the pixel to the intermediate grayscale.

5. An electrophoretic display device comprising:
a display unit having an electrophoretic element interposed between a pair of substrates, a pixel, a pixel electrode provided for the pixel and an opposite electrode facing the pixel electrode via the electrophoretic element; and
a control unit that controls driving of the pixel,
wherein, when performing an intermediate grayscale display of the pixel, the control unit performs a first display operation for changing a grayscale of the pixel to a first grayscale, a discharge operation for removing charges of the pixel electrode and the opposite electrode and a second display operation for changing the grayscale of the pixel to an intermediate grayscale by inputting a potential for changing the grayscale of the pixel to a second grayscale to the pixel electrode and the opposite electrode.

6. The electrophoretic display device according to claim 5, wherein, in the second display operation, the grayscale of the pixel is changed to the intermediate grayscale of a grayscale value, which approximates more to the second grayscale than the first grayscale.

7. The electrophoretic display device according to claim 5, wherein the control unit further performs an image holding operation for maintaining a high impedance state of the pixel electrode and the opposite electrode, after the second display operation.

8. The electrophoretic display device according to claim 5, wherein the control unit further performs a standby operation for maintaining a high impedance state of the pixel electrode and the opposite electrode between the discharge operation and the second display operation.

9. An electrophoretic display device comprising:
a display unit having an electrophoretic element interposed between a pair of substrates, a pixel, a pixel electrode provided for the pixel and an opposite electrode facing the pixel electrode via the electrophoretic element; and
a control unit that controls driving of the pixel,
wherein, when performing of an intermediate grayscale display of the pixel, the control unit performs a first display operation for changing a grayscale of the pixel to a first grayscale, and a second display operation for changing the grayscale of the pixel to an intermediate grayscale of a grayscale value, which approximates more to the second grayscale than the first grayscale, by inputting a potential for changing the grayscale of the pixel to a second grayscale to the pixel electrode and the opposite electrode.

10. An electronic apparatus comprising the electrophoretic display device according to claim 5.

11. An electronic apparatus comprising the electrophoretic display device according to claim 6.

12. An electronic apparatus comprising the electrophoretic display device according to claim 7.

13. An electronic apparatus comprising the electrophoretic display device according to claim 8.

14. An electronic apparatus comprising the electrophoretic display device according to claim 9.
